(19) United States
(12) Patent Application Publication
(10) Pub. No.: US 2020/0250758 A1
(43) Pub. Date: Aug. 6, 2020

(54) SYSTEMS AND METHODS FOR IMPROVING SOCIAL IMPACT INVESTMENT PLATFORMS

(71) Applicant: INVESTACURE, PBC, New York, NY (US)

(72) Inventors: Maxim TOKARSKY, Brooklyn, NY (US); Lawrence PINE, Highland Park, NJ (US)

(21) Appl. No.: 16/269,537

(22) Filed: Feb. 6, 2019

(51) Int. Cl. G06Q 40/06; G06Q 50/00; H04L 29/08

(52) U.S. Cl. CPC G06Q 40/06; H04L 67/22; G06Q 50/01

(57) ABSTRACT

Embodiments of the disclosure can relate to systems and methods for improving social impact investing through community social impact metrics. In various embodiments, an investment application executing on a mobile device and/or server may allow a user to invest in an entity, which may be a for-profit organization with a social goal, such as curing a disease. The user may desire to invest in the entity to produce a social impact, rather than a monetary return. Multiple users may form communities through the investment application that allow the users to collectively invest in a single or multiple entities and/or social goals. The users may be able to view individual metrics about their investments, and may also be able to view various monetary and social community-wide aggregated investment metrics. These community investment metrics may serve to quantify the social impacts of such investments, and encourage further investment.

### BACKGROUND

With the advent of social impact investing, individuals are now making investments in organizations, which may even be for-profit organizations, with the end goal being a desired social impact, such as developing a cure for a particular disease, rather than the traditional monetary return on the investment. Conventional platforms for performing “social impact investments” exist, but may not provide comprehensive metrics for tracking both individual investors and communities of investors with a social goal in mind. Without having such metrics, potential investors might be wary to invest because the results of their investments might not be as easy to quantitatively measure as a purely financial investment.

### SUMMARY OF THE DISCLOSURE

Systems and methods for improving social impact platforms disclosed. Further, certain embodiments of the disclosure can also provide systems and methods for improving social impact investment platforms and systems through the use of community social impact investing metrics. Systems and methods according to certain embodiments of the disclosure can enhance social impact investments by providing a platform that creates and tracks communities of users performing such social impact investing, where the communities of users may be organized based on a common social goal. In such a platform, the communities can be provided information about individual and aggregate metrics, such as a total amount of money raised and certain milestones achieved in pursuit of the end social goal (e.g., number of clinical trials performed in pursuit of a cure for a disease). Providing such aggregate metrics may serve to incentivize users to participate in such investments because they are able to view the quantitative, tangible results of their social-oriented investments.

In various embodiments, a computer-implemented method for investing is provided. The computer-implemented method may include receiving, via a first computing device from a first user, a first contribution, wherein the first contribution is based at least in part on a first round-up transaction, a first recurring transaction, or a first one-time transaction. In various embodiments, the method may also include receiving, via the first computing device, from the first user, a first user selection of a first user investment in an entity. In various embodiments, the method may also include providing, via the first computing device, a communication to a second user regarding the first user investment in the entity. In various embodiments, the method may also include receiving, via a second computing device, from the second user, a second contribution, wherein the second contribution is based at least in part on a second round-up transaction, a second recurring transaction, or a second one-time transaction. In various embodiments, the method may also include receiving, via the second computing device, from the second user, a second user selection of a second user investment in the entity. In various embodiments, the method may also include purchasing, via a processor-based device, an investment in the entity using the first contribution and the second contribution. In various embodiments, the method may also include outputting, via a display device, to the first user, a first cumulative investment metric. In various embodiments, the method may also include outputting, via a display device, to the second user, a second cumulative investment metric. In various embodiments, the method may also include outputting, via a display device, to either the first or second user, one or more community investment metrics.

In various embodiments, a system for investing is provided. The system may include at least one memory configured to store computer-executable instructions; and at least one processor configured to access the at least one memory and execute the computer-executable instructions. In various embodiments, the computer-executable instructions may cause the system to receive, via a first computing device from a first user, a first contribution, wherein the first contribution is based at least in part on a first round-up transaction, a first recurring transaction, or a first one-time transaction. In various embodiments, the computer-executable instructions may cause the system to receive, via the first computing device, from the first user, a first user selection of a first user investment in an entity. In various embodiments, the computer-executable instructions may cause the system to provide, via the first computing device, a communication to a second user regarding the first user investment in the entity. In various embodiments, the computer-executable instructions may cause the system to receive, via a second computing device from the second user, a second contribution, wherein the second contribution is based at least in part on a second round-up transaction, a second recurring transaction, or a second one-time transaction. In various embodiments, the computer-executable instructions may cause the system to receive, via the second computing device, from the second user, a second user selection of a second user investment in the entity. In various embodiments, the computer-executable instructions may cause the system to purchase, via a processor-based device, an investment in the entity using the first contribution and the second contribution. In various embodiments, the computer-executable instructions may cause the system to output, via a display device to the first user, a first cumulative investment metric. In various embodiments, the computer-executable instructions may cause the system to output, via a display device to the second user, a second cumulative investment metric. In various embodiments, the computer-executable instructions may cause the system to output, via a display device to either the first or second user, one or more community investment metrics.

In various embodiments, the one or more community investment metrics comprise at least a total investment amount and/or a current social impact. The total investment amount may include a sum of the first cumulative investment metric and the second cumulative investment metric. The current social impact may include at least one of a number of clinical trials enabled and a total number of pathways to a cure investigated.

In various embodiments, the communication to the second user regarding the first user investment in the entity may include providing a link to a social media platform to post information about the first user investment in the entity, an invitation to invest in the entity, and a communication sharing information about the first user investment in the entity to a group of friends or contacts.

In various embodiments, the first user and/or the second user are respectively provided a first community status and a second community status, wherein the first community status and the second community status are respectively based at least in part on the first cumulative investment amount or second cumulative investment amount. They may also include sending an invitation to a third user to join the first investment community. They may also include creating a second investment community comprising the first user, the second user, the third user, and/or a fourth user.

In various embodiments, the first investment and second investment are provided to a for-profit organization.

In various embodiments, the methods and systems described herein may further include creating a first investment community comprising at least the first user and/or the second user.

Additional systems, methods, apparatus, features, and aspects are realized through the techniques of various embodiments of the disclosure. Other embodiments and aspects of the disclosure are described in detail herein and are considered a part of the claimed subject matter. Other features can be understood and will become apparent with reference to the description and to the drawings.

### BRIEF DESCRIPTION OF THE FIGURES

FIG. 1 illustrates a block diagram of an example system architecture in accordance with at least one embodiment of the disclosure.

FIG. 2 illustrates a flow chart of an example flow diagram of an example process in accordance with at least one embodiment of the disclosure.

FIGS. 3 to 8C illustrate example user interfaces in accordance with at least one embodiment of the disclosure.

### DETAILED DESCRIPTION

Systems and methods for improving social impact platforms and systems is disclosed. Further, certain embodiments of the disclosure are directed to systems and methods for improving social impact investing through community social impact metrics. In various embodiments, a user may interact with an investment application through a mobile device, wherein the investment application may execute on the mobile device and/or a server. Through the investment application, the user may invest in one or more organizations with particular social goal(s) (e.g., curing a disease). The investments may be in the form of contributions derived from one or more round-up transactions, recurring transactions, or one-time transactions. The contributions may be facilitated through the investment application itself, or may also be facilitated through independent purchases made on, for example, a wallet application of the user's mobile device. For example, a credit and/or debit card stored in the wallet application may be linked with the investment application, so that transactions made with the credit and/or debit card may be rounded-up, and that rounded-up amount may be contributed as part of an investment made through the investment application.

In various embodiments, users may be able to establish communities through the investment application. A community may, for example, encompass a number of users who contribute to a common social goal by investing user contributions in one or more entities with the same social goal. In one instance, a common goal may be a single social directive, such as curing a particular disease. The community may alternatively encompass a number of users who contribute to a single organization with multiple social goals. Multiple communities including any number of users may be created through the investment application. Users within the various communities might also be afforded particular statuses that may relate to factors such as the amount of contributions that the users have made relative to other users within the community. The statuses may afford the users certain incentives, such as discounts at retail stores. The investment application may also allow users to invite others to join a community and/or make a contribution. An invitation to any number of users may be facilitated through the investment application, and may involve a post to a user's social media account with a link for the user's social media friends and/or contacts to join the community and/or make a contribution.

In various embodiments, users may be able to view metrics pertaining to their own individual contributions as well as community investment metrics that may pertain to contributions from multiple users within a community. Users may also be able to view metrics that span multiple or all communities associated with the investment application. For example, community investment metrics may include monetary-based metrics, such as an aggregate amount contributed by the community, or social-based metrics, such as a number of clinical trials completed as a result of the contributions received by the users.

Certain embodiments of the disclosure can achieve the technical effect of improving the operation of social impact investment platforms and systems. The implementation and tracking of certain metrics, including the display of some or all of certain metrics can enhance or otherwise increase the effectiveness, reach, and visibility of social impact investment platforms and systems. Further, the utilization and implementation of social media links and functionality with the operation of social impact investment platforms and systems can also enhance or otherwise increase the effectiveness, reach, and visibility of such social impact investment platforms and systems. Finally, the formation and use of communities designating any number of users to contribute to a common social goal by investing user contributions in one or more entities with the same social goal can also enhance or otherwise increase the effectiveness, reach, and visibility of such social impact investment platforms and systems.

Certain embodiments of the disclosure may also achieve the technical effect of improving the operation of social impact investment platforms and systems by tracking and displaying certain quantitative social impact metrics, including metrics pertaining to social impacts of investments, through one or more user interfaces generated in connection with a social impact investment platform. Without the ability to present such quantitative information via one or more user interfaces, potential investors may be wary to invest because the results of their investments might not be as easy to quantitatively measure as a purely financial investment. For example, if a user or community of users are interested in investing in an entity performing cancer research, the presence of quantitative information via one or more user interfaces might incentivize such users to invest if they are able to view a metric indicating that a total investment of $50,000 resulted in five cancer research trials.

Certain embodiments of the disclosure may also achieve the technical effect of improving the operation of social impact investment platforms and systems by displaying, or causing to display, a comprehensive user interface including at least various individual and community-wide metrics, including metrics pertaining to social impacts of investments made by users (e.g., how the individual or community-wide investments have helped an entity move closer to achieving a social goal), as well as user statuses, for various communities within the platform. Such displays via a comprehensive user interface can enhance or otherwise increase the scope and reach of such social impact investment platforms and systems.

Embodiments of the disclosure now will be described more fully hereinafter with reference to the accompanying drawings, in which certain embodiments are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

### Example System and Associated Architecture

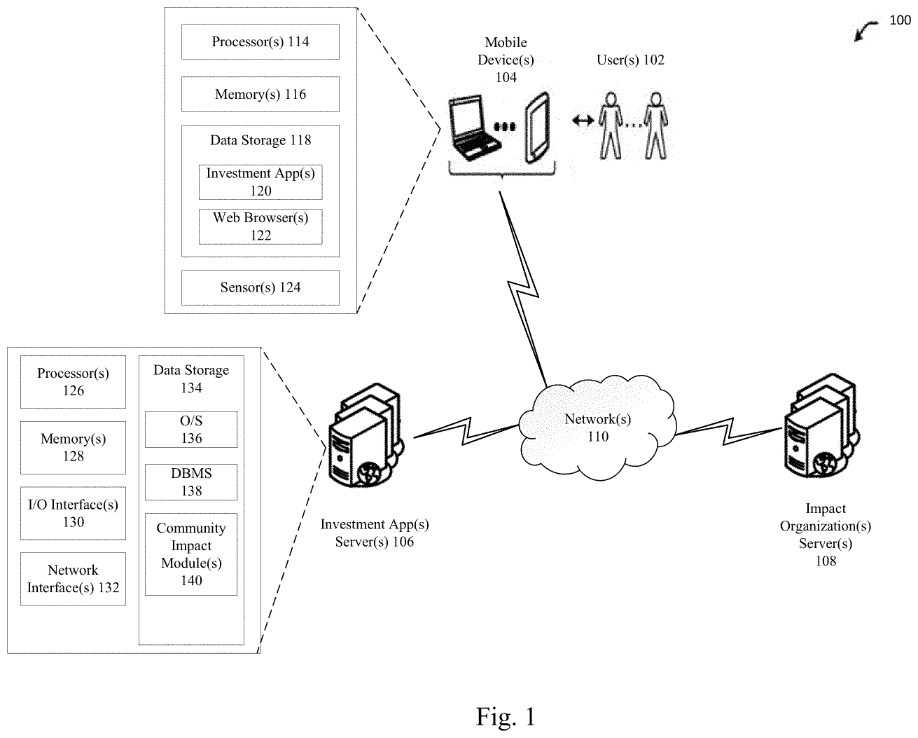

FIG. 1 is a block diagram of an example system architecture in accordance with one or more embodiments of the disclosure. One or more users 102 may interact with the system 100. The illustrative system 100 may include one or more mobile devices 104 operable by a respective user 102, one or more investment application servers 106, and one or more impact organization servers 108. The mobile devices 104 may include any of the types of devices described through reference to FIG. 1.

Any of the mobile devices 104, investment application servers 106, and impact organization servers 108 may be configured to communicate with each other and any other component of the system 100 via one or more networks 110. The network 110 may include, but is not limited to, any one or a combination of different types of suitable communications networks such as, for example, cable networks, public networks (e.g., the Internet), private networks, wireless networks, cellular networks, or any other suitable private and/or public networks. Further, the network 110 may have any suitable communication range associated therewith and may include, for example, global networks (e.g., the Internet), metropolitan area networks (MANs), wide area networks (WANs), local area networks (LANs), or personal area networks (PANs). In addition, the network 110 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Each of the mobile devices 104 may include one or more processors 114 that may include any suitable processing unit capable of accepting digital data as input, processing the input data based on stored computer-executable instructions, and generating output data. The computer-executable instructions may be stored, for example, in the data storage 118 and may include, among other things, operating system software and application software. The computer-executable instructions may be retrieved from the data storage 118 and loaded into the memory 116 as needed for execution. The processor 114 may be configured to execute the computer-executable instructions to cause various operations to be performed. Each processor 114 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 118 may store program instructions that are loadable and executable by the processors 114, as well as data manipulated and generated by one or more of the processors 114 during execution of the program instructions. The program instructions may be loaded into the memory 116 as needed for execution. Depending on the configuration and implementation of each of the mobile devices 104, the memory 116 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 116 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

Various program modules, applications, or the like may be stored in data storage 118 that may comprise computer-executable instructions that when executed by one or more of the processors 114 cause various operations to be performed. The memory 116 may have loaded from the data storage 118 one or more operating systems (O/S) that may provide an interface between other application software (e.g., dedicated applications, a browser application, a web-based application, a distributed client-server application, etc.) executing on the mobile device 104 and the hardware resources of the mobile device 104. More specifically, the 0/S may include a set of computer-executable instructions for managing the hardware resources of the mobile devices 104 and for providing common services to other application programs (e.g., managing memory allocation among various application programs). The O/S may include any operating system now known or which may be developed in the future including, but not limited to, any mobile operating system, desktop or laptop operating system, mainframe operating system, or any other proprietary or open-source operating system.

The data storage 118 may additionally include various other program modules that may include computer-executable instructions for supporting a variety of associated functionality. For example, the data storage 118 may include one or more applications, including one or more investment applications 120, or apps and/or one or more web browser(s) 122. In the embodiment shown, an investment application 120 can include computer-executable instructions that in response to execution by one or more processors 114 cause operations to be performed including receiving, via a first computing device from a first user, a first contribution, wherein the first contribution is based at least in part on a first round-up transaction, a first recurring transaction, or a first one-time transaction. The operations to be performed may also include receiving, via the first computing device, from the first user, a first user selection of a first user investment in an entity. The operations to be performed may also include providing, via the first computing device, a communication to a second user regarding the first user investment in the entity. The operations to be performed may also include receiving, via a second computing device, from the second user, a second contribution, wherein the second contribution is based at least in part on a second round-up transaction, a second recurring transaction, or a second one-time transaction. The operations to be performed may also include receiving, via the second computing device, from the second user, a second user selection of a second user investment in the entity. The operations to be performed may also include purchasing, via a processor-based device, an investment in the entity using the first contribution and the second contribution. The operations to be performed may also include outputting, via a display device, to the first user, a first cumulative investment metric. The operations to be performed may also include outputting, via a display device, to the second user, a second cumulative investment metric. The operations to be performed may also include outputting, via a display device, to either the first or second user, one or more community investment metrics.

In some embodiments, an investment application 120 may include computer-executable instructions that in response to execution by one or more of the processors 114 cause operations to be performed including at least creating user accounts, receiving contributions from users 102 and directing those contributions to the investment application servers 106, displaying information regarding user 102 contributions and social impact and other various metrics, and allowing users 102 to create communities and invite social media contacts to join and contribute, among other operations.

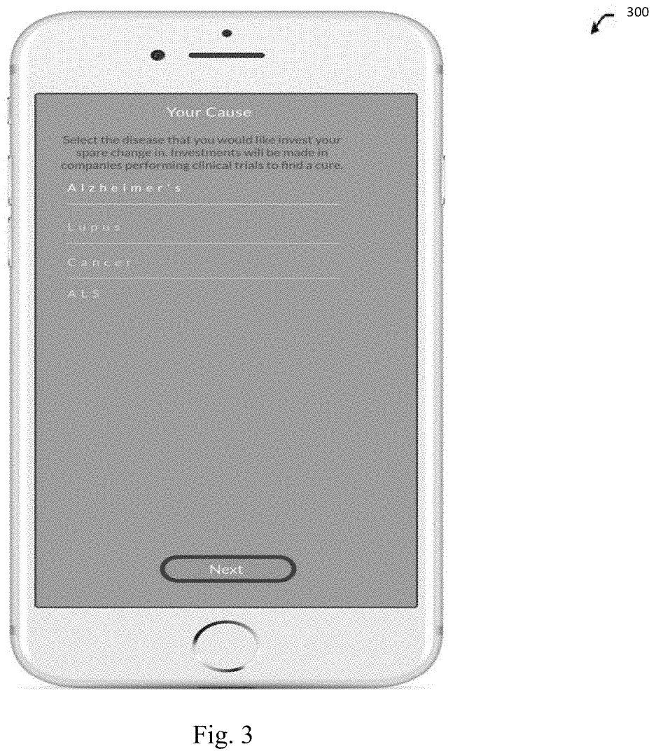

In some embodiments, the investment applications 120 may include user interfaces used to display the application to a user 102. Such user interfaces are discussed in more detail below with regards to FIGS. 3 to 8C.

In some embodiments, one or more users 102 may be able to create respective user accounts through the investment application 120. A user account may allow a user 102 to interact with an investment application server 106 to perform operations such as investing in certain entities, being a part of investment communities, and viewing investment and social impact metrics, among others. In some embodiments, the one or more web browsers 122 may include computer-executable instructions that in response to execution by the processors 114 cause operations to be performed including accessing websites, sending and receiving requests for data, and the like.

The mobile devices 104 may include one or more sensor devices 124, such as image sensors and/or collection devices (e.g., a microphone, cameras, video cameras, near field communication (NFC) scanners, RF scanners, infrared scanners, quick response (QR) code scanners, etc.) to capture one or more universal resource identifiers (URIs).

The investment application servers 106 may include one or more processors 126, and one or more memories 128 (referred to herein generically as memory 128). The one or more processors 126 may include any suitable processing unit capable of accepting digital data as input, processing the input data based on stored computer-executable instructions, and generating output data. The computer-executable instructions may be stored, for example, in the data storage 134 and may include, among other things, operating system software and application software. The computer-executable instructions may be retrieved from the data storage 134 and loaded into the memory 128 as needed for execution. The one or more processors 126 may be configured to execute the computer-executable instructions to cause various operations to be performed. The one or more processors 126 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 134 may store program instructions that are loadable and executable by the one or more processors 126, as well as data manipulated and generated by the one or more processors 126 during execution of the program instructions. The program instructions may be loaded into the memory 128 as needed for execution. Depending on the configuration and implementation of the one or more investment application servers 106, the memory 128 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 128 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The one or more investment application servers 106 may further include additional data storage 134 such as removable storage and/or non-removable storage including, but not limited to, magnetic storage, optical disk storage, and/or tape storage. Data storage 134 may provide non-volatile storage of computer-executable instructions and other data. The memory 128 and/or the data storage 134, removable and/or non-removable, are examples of computer-readable storage media (CRSM).

The one or more investment application servers 106 may further include network interfaces 132 that facilitate communication between the one or more investment application servers 106 and other devices of the illustrative system 100 (e.g., mobile devices 104, investment application servers 106, etc.) or application software via the network 110. The one or more investment application servers 106 may additionally include one or more respective input/output (I/O) interfaces 130 (and optionally associated software components such as device drivers) that may support interaction between a user and a variety of I/O devices, such as a keyboard, a mouse, a pen, a pointing device, a voice input device, a touch input device, gesture detection or input device, a display, speakers, a camera, a microphone, a printer, and so forth.

Referring again to the data storage 134, various program modules, applications, or the like may be stored therein that may comprise computer-executable instructions that when executed by the one or more processors 126 cause various operations to be performed. The memory 128 may have loaded from the data storage 134 one or more operating systems (O/S) 136 that may provide an interface between other application software (e.g., dedicated applications, a browser application, a web-based application, a distributed client-server application, etc.) executing on the one or more investment app servers 106 and the hardware resources of the investment app server(s) 106. More specifically, the 0/S 136 may include a set of computer-executable instructions for managing the hardware resources of the investment application servers 106 and for providing common services to other application programs (e.g., managing memory allocation among various application programs). The O/S 136 may include any operating system now known or which may be developed in the future including, but not limited to, any mobile operating system, desktop or laptop operating system, mainframe operating system, or any other proprietary or open-source operating system.

The data storage 134 may further include one or more database management systems (DBMS) 138 for accessing, retrieving, storing, and/or manipulating data stored in one or more datastores. The DBMS 138 may use any of a variety of database models (e.g., relational model, object model, etc.) and may support any of a variety of query languages.

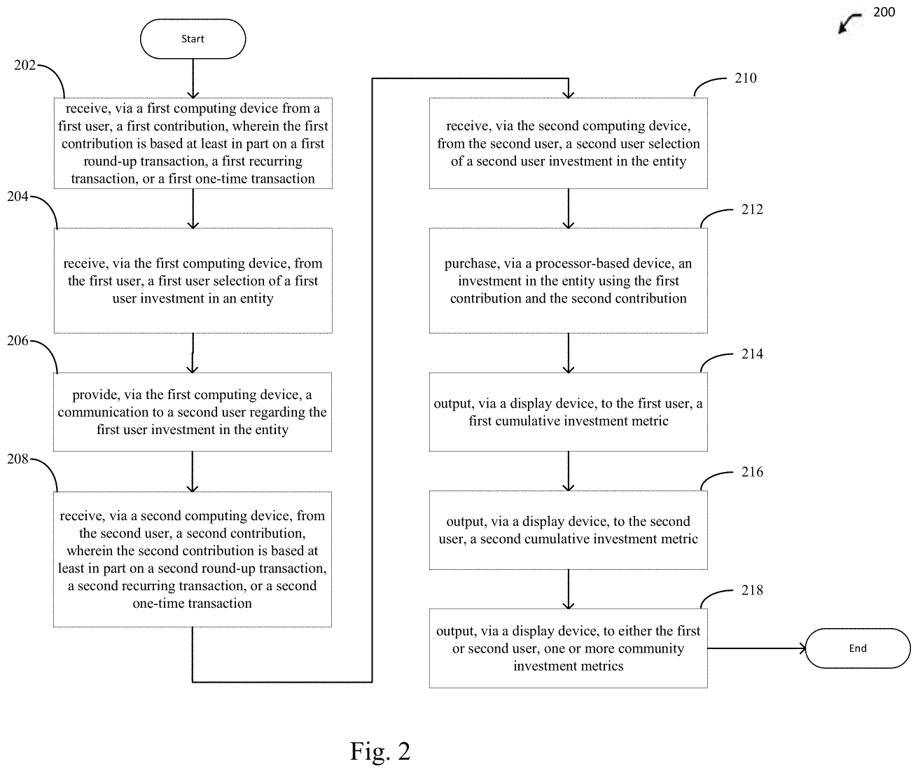

The data storage 134 may additionally include various other program modules that may include computer-executable instructions for supporting a variety of associated functionality. For example, the data storage 134 may include one or more community impact modules 140. The one or more community impact modules 140 may include computer-executable instructions that in response to execution by the one or more processors 126 cause operations to be performed including receiving, storing, and sending contributions provided by a user 102 through an investment application 120, and/or performing any of the operations described below with regards to FIG. 2, among other operations.

Within the data storage 134, one or more modules may be stored. As used herein, the term module may refer to a functional collection of instructions that may be executed by the one or more processors 126. For ease of description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

The one or more impact organization servers 108 may be one or more servers associated with one or more entities that any number of users of investment applications 120 decide to invest in. An impact organization server 108 may receive investments from the one or more investment application servers 106, and may also provide information back to the investment application servers 106, such as current social impact information.

Those of skill in the art will appreciate that any of the components of the system 100 and associated architecture may include alternate and/or additional hardware, software, or firmware components beyond those described or depicted without departing from the scope of the disclosure. More particularly, it should be appreciated that hardware, software, or firmware components depicted or described as forming part of any of the illustrative components of the system 100, and the associated functionality that such components support, are merely illustrative and that some components may not be present or additional components may be provided in various embodiments. While various program modules have been depicted and described with respect to various illustrative components of the system 100, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of skill in the art will appreciate that the illustrative system 100 is provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system 100, or additional functionality.

### Example Processes

FIG. 2 illustrates a flow diagram of an example process 200 in accordance with one or more embodiments of the disclosure.

In various embodiments, at block 202, an investment application server, such as 106 in FIG. 1, may receive, via a first computing device from a first user, a first contribution, wherein the first contribution is based at least in part on a first round-up transaction, a first recurring transaction, or a first one-time transaction. The first contribution may be representative of an investment from a single user, such as 102. The first contribution may be a monetary investment and may be intended to be invested in an organization with a social goal (e.g., curing a disease). In some instances, the organization may be a for-profit organization. In some instances, the contributions may be stored by the investment application, such as 120, or investment application server 106, and the investment may be provided to a third party organization at a later time. In other instances, the contribution may be immediately invested in the third party organization.

In various embodiments, the contribution may be in the form of a round-up transaction, a first recurring transaction, or a first one-time transaction. A round-up transaction may involve rounding up an amount of money spent on a transaction (e.g., purchase at a retail store) to the next dollar amount, and contributing the difference between the rounded-up dollar amount and the original dollar amount. For example, if a user 102 spends $10.50 at a retail establishment, the transaction would be rounded up to $11.00, and the contribution would be 50 cents. A recurring transaction may refer to a contribution amount that is established by the user 102 to be contributed on a recurring or periodic basis. For example, a user 102 may indicate that they want to contribute $30 every month. Finally, a one time-contribution may be a single contribution that, instead of being made periodically, is only made at one point in time. For example, a user 102 may indicate that they want to contribute $100. In various embodiments, a user 102 may provide a contribution through any other type of transaction from any other source.

In various embodiments, at block 204, an investment application server 106 may receive, via the first computing device, from the first user, a first user selection of a first user investment in an entity. In some instances, the entity may be an organization with a particular social goal (e.g., finding a cure for cancer). In some instances, the entity may also be a for-profit organization. Upon providing a contribution, a user 102 may be able to select one or more entities that they desire to invest in through their contribution. The investment may be intended to result in a particular social impact in order to achieve an ultimate social goal instead of a monetary return to the user 102. For example, a user 102 may be interested in funding cancer research to find a cure for a particular type of brain cancer. The user 102 may make a contribution and subsequently select one or more cancer research institutions or other organizations to invest in using their contribution. The selection of the entity in which the user 102 wishes to invest may be made through the investment application 120.

In various embodiments, at block 206, an investment application server 106 may provide, via the first computing device, a communication to a second user regarding the first user investment in the entity. In some instances, the communication to the second user regarding the first user investment in the entity includes providing a link to a social media platform to post information about the first user investment in the entity, an invitation to invest in the entity, and a communication sharing information about the first user investment in the entity to a group of friends or contacts. For example, a user 102 may make a contribution to an organization performing cancer research. The user 102 may be provided an option to post an indication on one or more of the user's social media accounts that he or she made the contribution. The post might also contain a link or other means for the user's social media connections to make their own contributions to the same or other entities. The post might also contain information about the entity and/or the social impact or social goal of the entity, and a link for the user's social media connections to create an account through the investment application server 106 and download the investment application 120 to their respective mobile devices 104.

In various embodiments, at block 208, an investment application server 106 may receive, via a second computing device, from the second user, a second contribution, wherein the second contribution is based at least in part on a second round-up transaction, a second recurring transaction, or a second one-time transaction. The second contribution may be representative of an investment from a single user 102, who may be a different user 102 than the first user. The second contribution may be a monetary investment and may be intended to be invested in an organization with a goal to achieve a socially-desirable result (e.g., curing a disease). In some instances, the organization may be a for-profit organization. In some instances, the contributions may be stored by the investment application 120 or investment application server 106, and the investment may be provided to a third party organization at a later time. In other instances, the contribution may be immediately invested in the third party organization.

In various embodiments, the contribution may be in the form of a round-up transaction, a first recurring transaction, or a first one-time transaction. A round-up transaction may involve rounding up the amount of money spent on a transaction (e.g., purchase at a retail store) to the next dollar amount, and contributing the difference between the rounded-up dollar amount and the original dollar amount. For example, if a user 102 spends $10.50 at a retail establishment, the transaction would be rounded up to $11.00, and the contribution would be 50 cents. A recurring transaction may refer to a contribution amount that is established by the user 102 to be contributed on a recurring or periodic basis. For example, a user 102 may indicate that they want contribute $30 every month. Finally, a one time-contribution may be a single contribution that, instead of being made periodically, is only made at one point in time. For example, a user 102 may indicate that they want to contribute $100. In various embodiments, a user 102 may provide a contribution through any other type of transaction from any other source.

In various embodiments, at block 210, an investment application server 106 may receive, via the second computing device, from the second user, a second user selection of a second user investment in the entity. The second user may invest in the same entity as the first user, or any number of other entities with social impact goals. In some instances, the entity may also be a for-profit organization. Upon providing a contribution, a user 102 may be able to select one or more entities that they desire to invest in through their contribution. The investment may be intended to result in a particular social impact and achieve a social goal instead of a monetary return to the user 102. For example, a user 102 may be interested in funding cancer research to find a cure for a particular type of brain cancer. The user 102 may make a contribution and subsequently select one or more cancer research institutions or other organizations to invest in using their contribution. The selection of the entity in which the user 102 wishes to invest may be made through the investment application 120.

In various embodiments, at block 212, an investment application server 106 may purchase, via a processor-based device, an investment in the entity using the first contribution and the second contribution. The purchase of the investment may also be made based on only the first or second contributions individually. In some instances, multiple investment purchases may be made in any combination of entities. For example, a first user might contribute $40 and a second user contributes $50. The investment application server 106 may invest $90 in a single cancer research organization, or may invest $40 in one organization and $50 in another. Any number of other investment amounts and distributions may be possible.

In various embodiments, at block 214, an investment application server 106 may output, via a display device, to the first user, a first cumulative investment metric. In some instances, the first cumulative investment metric may be provided by the investment application server 106, to an investment application 120 of a mobile device 104, and the first user may subsequently be able to view the cumulative investment metric on one or more user interfaces of the investment application 120 (described in greater detail below with regards to FIGS. 3-8C). The first cumulative investment metric may not be limited to viewing by only the first user, but may optionally also be viewed by any number of other users 102 on any number of mobile devices 104.

In various embodiments, the first cumulative investment metric may represent a current total amount contributed or invested by the first user. For example, the first user may provide a first contribution of $50.00 on a first day, and may subsequently provide a second contribution of $40.00 on a second day. The first cumulative investment metric would indicate that the first user has contributed a total of $90.00. The first cumulative investment metric may also be representative of contributions directed towards a specific organization or a specific social goal. For example, the first user may contribute a total of $60 at various intervals over a year for cancer research and may contribute a total of $75 at various intervals over a year for diabetes research. There may exist multiple cumulative investment metrics, one for each organization or specific social goal (e.g., a cumulative investment metric indicating that $60 has been contributed for cancer research and a cumulative investment metric indicating that $75 has been contributed for diabetes research). The first cumulative investment metric may also optionally indicate a total number of contributions, regardless of organization or goal. For example, if the first user contributes $60 to cancer research and $75 to diabetes research, then the first cumulative investment metric may indicate that a total of $135 has been contributed by the first user. Any number of other combinations may also be possible.

In various embodiments, at block 216, an investment application server 106 may output, via a display device, to the second user, a second cumulative investment metric. In some instances, the second cumulative investment metric may be provided by the investment application server 106, to an investment application 120 of a mobile device 104, and the second user may subsequently be able to view the cumulative investment metric on one or more user interfaces of the investment application 120. The second cumulative investment metric may not be limited to viewing by only the second user, but may optionally also be viewed by any number of other users 102 on any number of mobile devices 104.

In various embodiments, the second cumulative investment metric may represent a current total amount contributed or invested by the second user. For example, the second user may provide a first contribution of $50.00 on a first day, and may subsequently provide a second contribution of $40.00 on a second day. The second cumulative investment metric would indicate that the first user has contributed a total of $90.00. The second cumulative investment metric may also be representative of contributions directed towards a specific organization or a specific social goal. For example, the second user may contribute a total of $60 at various intervals over a year for cancer research and may contribute a total of $75 at various intervals over a year for diabetes research. There may exist multiple second cumulative investment metrics, one for each organization or specific social goal (e.g., a second cumulative investment metric indicating that $60 has been contributed for cancer research and a second cumulative investment metric indicating that $75 has been contributed for diabetes research). The second cumulative investment metric may also optionally indicate a total number of contributions, regardless of organization or goal. For example, if the second user contributes $60 to cancer research and $75 to diabetes research, then the second cumulative investment metric may indicate that a total of $135 has been contributed by the second user. Any number of other combinations may also be possible.

In various embodiments, at block 218, an investment application server 106 may output, via a display device, to either the first or second user, one or more community investment metrics. The community investment metrics may provide information regarding all user contributions facilitated through investment applications 120 and/or the investment application server 106. In some instances, community investment metrics may include monetary-related metrics such as a total investment amount (e.g., a sum of the first cumulative investment amount and the second cumulative investment amount), a percentage of the total investment needed to increase the chanced that a disease cure is found, a total amount contributed by friends on a social network, a percentage of drug companies owned by network investors, a percentage of the total investment needed to reach a common need investment goal, or any number of other metrics. For example, the community impact metric may indicate that all of the users 102 combined have contributed a total of $500 to cancer research.

In some instances, community investment metrics may include social goal-related metrics, such as a current social impact. The current social impact may reflect particular result that came about because of the aggregate contributions made by users 102 to the investment application server 106 (e.g., because X amount of dollars have been contributed, the cancer research organization was able to fund five research trials). Examples of information encompassed by a current social impact may include, among others, a total number of clinical trials enables or a total pathways to a cure investigated. In some instances, the community investment metrics may include a combination of monetary-related metrics and social goal-related metrics.

In various embodiments, any of the aforementioned community investment metrics may be displayed on one or more user interface(s) of the investment applications 120. Thus, users 102 may be able to view the community investment metrics through the mobile devices 104 containing the investment applications 120. The display of any of these various community investment metrics is discussed in further detail with regard to FIGS. 3 to 8C.

In various embodiments, the first and second user may respectively be provided a first community status and second community status. The first community status and second community status may be respectively based at least in part on the first cumulative investment amount and the second cumulative investment amount. For example, a user 102 who has contributed $50 may be of one status, and a user who has contributed $600 may be of another status. In some embodiments, the statuses may be separated into tiers with each tier being achievable by reaching a certain threshold defined by particular criteria (e.g., contribution amounts, number of contributions, etc.). For example, the criteria may be contributions amounts. Thresholds for tiers one, two, and three status might be $50, $500, and $5000 dollars respectively. A first user who has contributed $600 would be tier three status, and a user who has contributed $10,000 would be tier three status. In further embodiments, the statuses may be any other kind of indicator that compares users 102 providing contributions to an investment application server 106. Additionally, statuses may be any sort of identifier that distinguishes a user of one status from a user of another status. A user 102 may have associated with them more than one status. For example, a user 102 may have a status for each of the organizations or social causes that the user has contributed to (e.g., one status for contributions to a cancer research organization, and a separate status for contributions to a diabetes research organization), or similarly may have a status for each community the user 102 is a part of.

In various embodiments, a status might also afford a user various incentives. For example, after reaching a certain status, a user 102 may be entitled to discounted purchases at a retailer. As another example, users of higher status might be privy to more information, or have more control over, operations of the social-goal organizations being invested in. The incentives may also optionally be provided to all users 102 who have made, or continue to make, contributions, regardless of their status. As a further example, the users 102 may be provided incentives merely for making contributions using a round-up contribution based on a payment transaction performed at a retailer location.

In various embodiments, users 102 may be able to create one or more investment communities within the investment application server 106. The one or more investment communities may be created through an investment application 120. The one or more investment communities may be accessible and viewable through the investment application 120. For example, a first and second user may create an investment community with a common goal of providing investments towards a particular cancer research organization. The community may contain information regarding the participating users 102, the organization being invested in, the social goal of the community and/or the organization, and any other type of relevant information. Users 102 of the community may also be able to view one or more metrics, which may include any individual contributions made by any users 102, the aforemtioned cumulative investment metrics, or the aforementioned community investment metrics. For example, the community may provide an indication that a first user has contributed $30 on one day, a second user has contributed $80 on another day, the first user has contributed a cumulative investment of $100, the second user has contributed a cumulative investment of $200, and the total community investment thus far is $300. Any number of other aforementioned metrics may also optionally be displayed, such as a total number of clinical trials enabled or a total pathways to a cure investigated. Any number of communities may exist within the investment application server 106 (e.g., a second community may also be created including the first, second, third, and a fourth user).

In various embodiments, users 102 may also be able to create one or more investment communities that might not necessarily have the same social impact goals. For example, communities may be based on relationships between the users (e.g., a workplace or a family). The community may be used to track individual and total contributions by members of the community, but the individual contributions might be directed towards differing social goals. For example, the community for a workplace might indicate that the employees have collectively contributed $15,000, with $7,500 going towards cancer research and $7,500 going towards diabetes research.

In various embodiments, users 102 within a community may also be able to invite other users 102 to join a community. The users 102 within the community may send invitations to other users 102 (e.g. a third user) who are registered with the investment application server 106 through user accounts, but are currently not a part of the specific community. The users 102 within the community may also send invitations through their social media accounts that contain links to register accounts with the investment application server 106 and/or join the community.

### Example User Interfaces

FIGS. 3 to 8C illustrate various examples of user interfaces, which may be displayed through an investment application 120 on a mobile device 104. In certain embodiments, some or all of these example user interfaces may represent improved user interfaces for a social impact investment platform because such user interfaces can display a comprehensive listing of information, including at least various individual and community-wide metrics, including metrics pertaining to social impacts of investments made by users (e.g., how the individual or community-wide investments have helped an entity move closer to achieving a social goal), as well as user statuses in various communities within the platform. The implementation and tracking of certain metrics, including the display of some or all of certain metrics can enhance or otherwise increase the effectiveness, scope, reach, and visibility of social impact investment platforms and systems. The user interfaces may also achieve the technical effect of providing a social investment platform that provides investors with quantitative information regarding the social impact of their investments. Without having such metrics, potential investors might be wary to invest because the results of their investments might not be as easy to quantitatively measure as a purely financial investment.

FIG. 3 illustrates an example user interface allowing a user, such as 102 in FIG. 1, to select a particular cause to provide contributions to. A cause may include one or more different types of diseases that the user 102 wants to contribute funding towards developing a cure for. A cause may not be limited to only curing diseases, but may alternatively include any other type of social goal that the user 102 wants to achieve (e.g., helping funding food shelters, provide scholarships to underprivileged students, etc.). The example user interface of FIG. 3 provides sample causes, including Alzheimer's, Lupus, Cancer, and ALS. In one embodiment, upon selection of a cause, the cause may be saved to the user's investment application account. Selecting a particular cause may allow the investment application, such as 120, to link the user 102 with one or more organizations associated with the cause. For example, upon a selection of “cancer”, a user might be linked to one cancer research institute, or might be linked to several cancer research institutes. Thus, when a user 102 makes a contribution to the cause, the contribution might be provided to the one or more linked organizations. In another embodiment, selecting a cause might not link a particular organization to the user account, but instead might allow the user 102 to contribute to the cause in general. For example, selecting “cancer” might allow the user to distribute their contributions among all cancer research organizations that the investment application 120 is able to transfer contributions to.

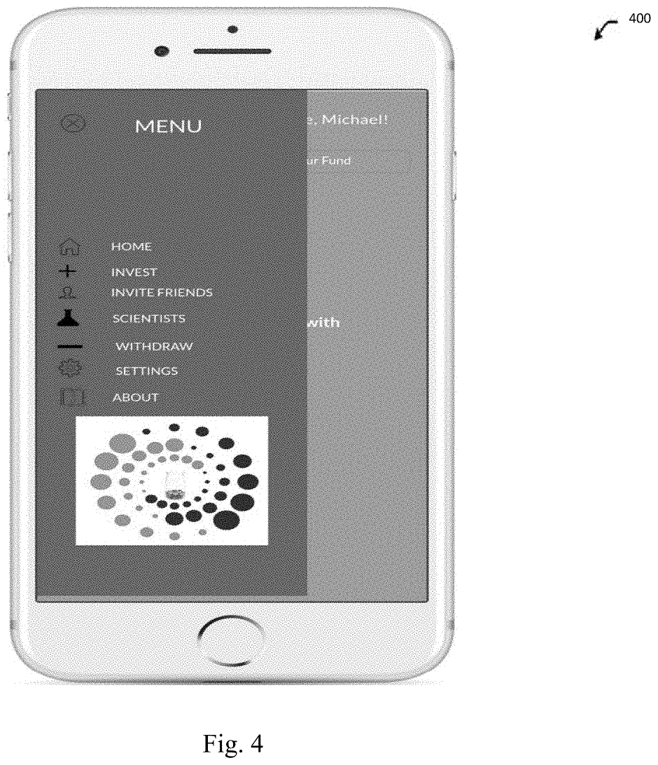

FIG. 4 illustrates an example user interface providing a user, such as 102 in FIG. 1, with a menu screen. In various embodiments, the menu screen may provide a number of functions to the user 102. For example, the menu screen may allow the user 102 to direct the investment application, such as 120, to the user interface FIG. 3, or any other similar user interface that would allow the user to make an investment in an entity. The menu screen may also allow the user 102 to redirect the investment application 120 to a user interface that would allow the user 102 to invite friends to download the investment application 120 and/or invest in entities, and/or join an investment community. The menu screen may also allow the user 102 to redirect the investment application 120 to a user interface that would allow the user 102 to view information about particular entities or individuals who work for the entities (or also standalone individuals performing studies or pursuing other social goals). The menu screen may also allow the user 102 to redirect the investment application 120 to a user interface where the user 102 would be able to withdraw contributed funds. The menu screen may also allow the user to redirect the investment application 120 to any number of other user interfaces described herein that provide any number of functionalities for the user 102.

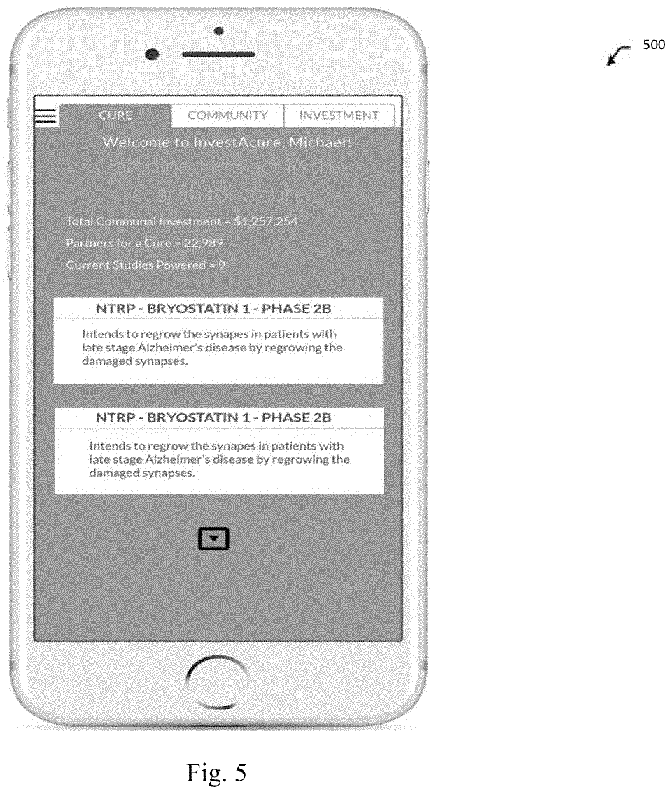

FIG. 5 illustrates an example user interface providing a user 102 with information pertaining to one or more cures, causes, social goals, or the like that the user 102 has or plans on contributing to.

In various embodiments, the user interface of FIG. 5 may display various metrics or other types of information. One type of metric may include a cumulative investment metric for the user, such as 102 in FIG. 1. In various embodiments, the cumulative investment metric may represent a current total amount contributed or invested by the user 102. For example, the user 102 may provide a first contribution of $50.00 on a first day, and may subsequently provide a second contribution of $40.00 on a second day. The cumulative investment metric would indicate that the user 102 has contributed a total of $90.00. The cumulative investment metric may also be representative of contributions directed towards a specific organization or a specific social goal. For example, the user 102 may contribute a total of $60 at various intervals over a year for cancer research and may contribute a total of $75 at various intervals over a year for diabetes research. There may exist multiple cumulative investment metrics, one for each organization or specific social goal (e.g., a cumulative investment metric indicating that $60 has been contributed for cancer research and a cumulative investment metric indicating that $75 has been contributed for diabetes research). The cumulative investment metric may also optionally indicate a total number of contributions, regardless of organization or goal. For example, if the user 102 contributes $60 to cancer research and $75 to diabetes research, then the cumulative investment metric may indicate that a total of $135 has been contributed by the user 102.

In various embodiments, another type of metric may include one or more community investment metrics. The community investment metrics may provide information regarding contributions of all user contributions facilitated through the investment application server, such as 106. In some instances, community investment metrics may include monetary-related metrics such as a total investment amount (e.g., a sum of the first cumulative investment amount and the second cumulative investment amount), a percentage of the total investment needed to increase the chanced that a disease cure is found, a total amount contributed by friends on a social network, a percentage of drug companies owned by network investors, a percentage of the total investment needed to reach a common need investment goal, or any number of other metrics. For example, the community impact metric may indicate that all of the users 102 combined have contributed a total of $500 to cancer research. An example monetary-related community investment metric is displayed as the “total community investment” with a value of “$1,257,254” in FIG. 5.

In various embodiments, community investment metrics may include social goal-related metrics, such as a current social impact. A current social impact may reflect a current social impact of the aggregate contributions made by users 102 to the investment application server 106 with relation to a social goal established, in some cases, by the organization receiving the contributions (e.g., for-profit cancer research institute). Examples of information encompassed by a current social impact may include, among others, a total number of clinical trials enables or a total pathways to a cure investigated. In some instances, the community investment metrics may include a combination of monetary-related metrics and social goal-related metrics. An example social goal-related community investment metric is displayed as “current studies powered” with a value of “9”. In various other embodiments, the user interface of FIG. 5 may display any other types of metrics.

In various embodiments, the user interface of FIG. 5 may display other types of metrics or information, such as the number of individuals contributing to the particular cure or social goal, or overviews of various current studies being performed to achieve the cure or social goal. The user interface of FIG. 5 may also display any other types of metrics or information that is relevant to the particular cure or social goal.

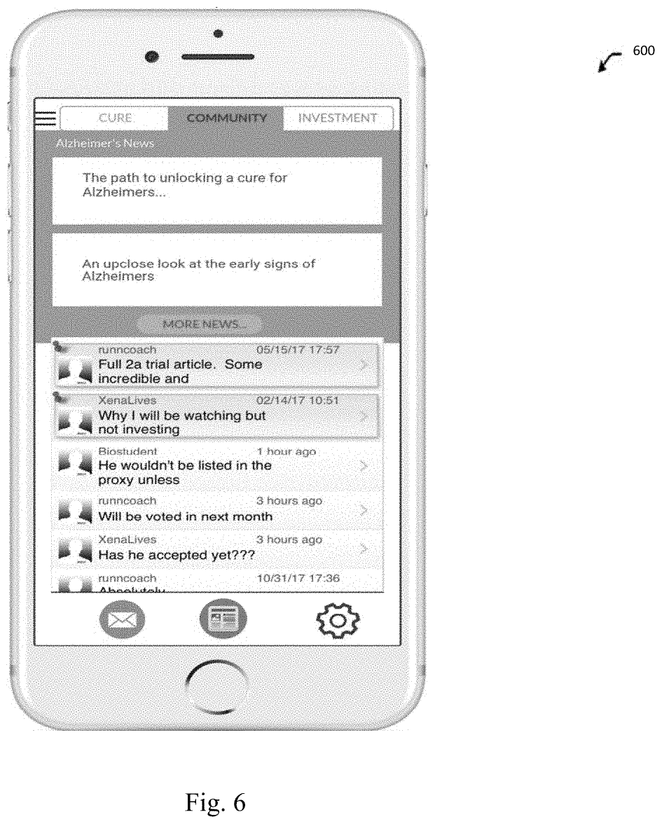

FIG. 6 illustrates an example user interface displaying information specific to a particular community. In various embodiments, the community user interface may include news about the entities that the community has invested in and the social impacts that have resulted, among other information. The community user interface may also include a section where users may post content, such as comments and links to articles. Users, such as 102 in FIG. 1, who may be members of the community may be able to interact with the postings through actions such as commenting.

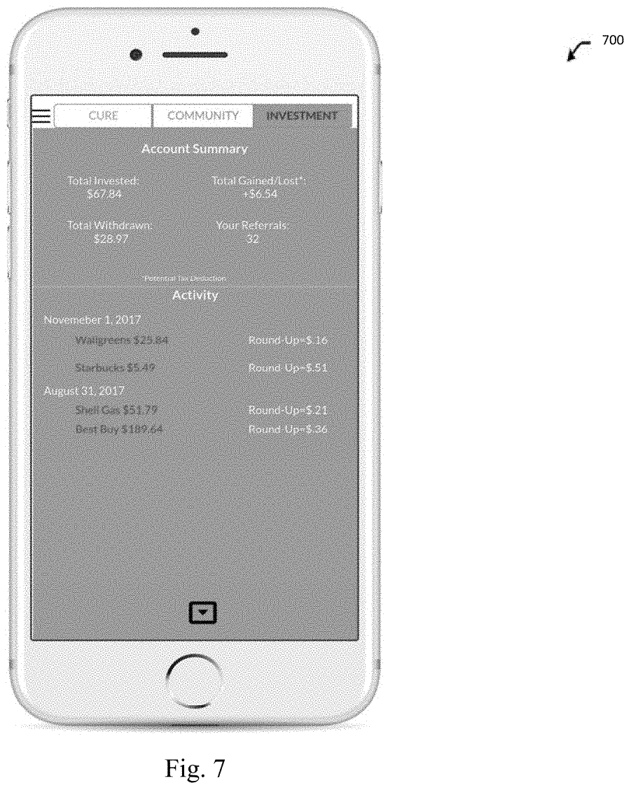

FIG. 7 illustrates an example user interface displaying an example user account summary page. In various embodiments, the user account summary page may provide various metrics and/or information pertaining to investments and/or transactions by a user, for example, 102 in FIG. 1. In some instances, the user account summary page may display a total amount invested, which may be the cumulative investment metric. The total amount invested value may refer to a total amount invested for a particular cure or social goal, or may refer to a total amount invested by the user 102 across all cures or social goals the user 102 is invested in. In some instances, the user account summary page may display a total withdrawn amount. The total withdrawn amount may refer to an amount of contributions that the user has withdrawn from an account of the investment application, such as 120. A user 102 may be able to supply funds to the investment application 120, and the funds may remain uninvited in the account until the user 102 directs the funds to a particular organization, cause, cure, social goal, etc. The user 102 may optionally also be able to withdraw an amount that has already been invested in some instances.

In some instances, the user account summary may also display a total number of referrals. The referral number may indicate how many referred users the user 102 has invited to contribute to the particular organization, cause, cure, social goal, etc. As described in further detail herein, the referred users may be invited through various means, such as a user's 102 social media page. In various embodiments, the user account summary page may also display recent account activity of the user 102. Account activity may refer to recent contributions that the user 102 has made. For example, the contributions may in the form of round-up transactions that the user 102 has made at various retail locations.

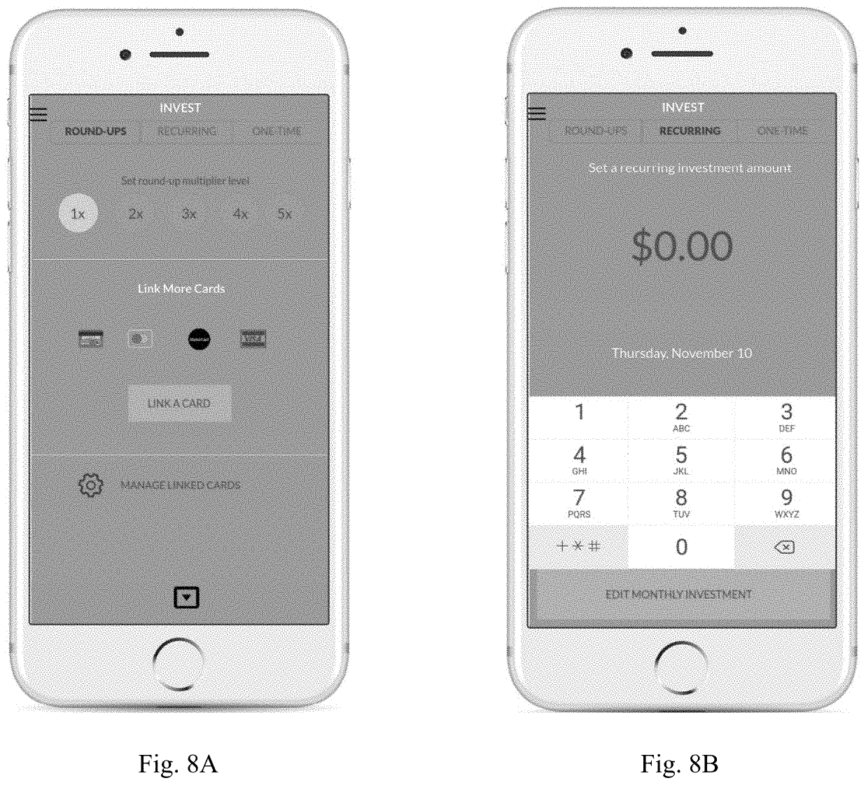

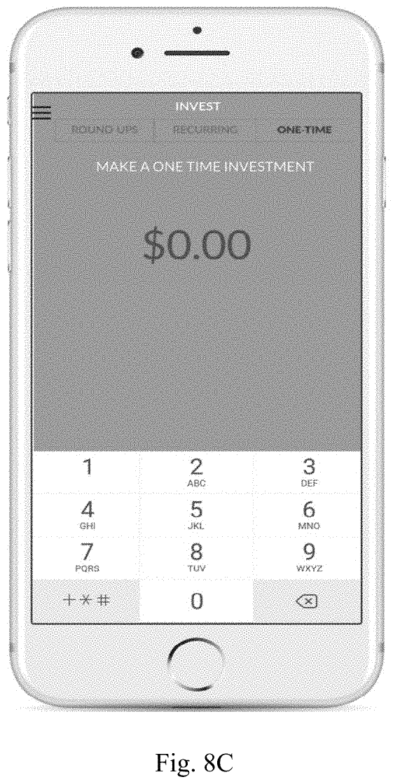

FIGS. 8A to 8C illustrate example user interfaces displaying various methods of providing monetary contributions to the investment application, such as 120 in FIG. 1. In various embodiments, a user 102 may choose to make contributions in the form of round-up contributions. FIG. 8A illustrates an example user interface displaying a page where round-up contributions may be initiated and configured. The round-up configuration user interface may provide a user 102 the capability to link one or more of their credit, debt, etc. cards to the investment application 102. The round-up configuration user interface may also provide the user 102 with the capability to select a round-up multiplier value, which may be a value multiplied by the original round-up amount to determine a multiplied contribution amount. For example, if a round-up transaction results in a round-up of 50 cents, and the multiplier is 2×, then the contribution would be $1.

In various embodiments, a user, such as 102 in FIG. 1, may choose to make contributions in the form of recurring contributions. FIG. 8B illustrates an example user interface displaying a page where recurring contributions may be initiated and configured. In various embodiments, the recurring contributions user interface may provide a user 102 the capability to enter a value indicating a dollar amount that the user 102 desires to contribute on a periodic basis (e.g., every month). The contributions may be drawn from a number of potential sources, such as credit or debit cards that the user 102 has linked to their investment application account.

In various embodiments, a user 102 may choose to make contributions in the form of a one-time contributions. FIG. 8C illustrates an example user interface displaying a page where a one-time contribution may be initiated and configured. In various embodiments, the one-time contribution user interface may provide a user 102 the capability to enter a value indicating a dollar amount that the user 102 desires to contribute. The contribution may be drawn from a number of potential sources, such as credit or debit cards that the user 102 has linked to their investment application account.

Note that references to “entities,” “organizations,” “institutes” or “institutions,′” or similar terms may be made interchangeably herein. All of these terms, including similar terms, refer to a third party and/or third parties that a user 102 or users 102 may invest in or otherwise contribute to.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the invention.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-readable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or operations to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or operations for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or operations, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving, via a first computing device from a first user, a first contribution, wherein the first contribution is based at least in part on a first round-up transaction, a first recurring transaction, or a first one-time transaction;
receiving, via the first computing device, from the first user, a first user selection of a first user investment in an entity;
providing, via the first computing device, a communication to a second user regarding the first user investment in the entity;
receiving, via a second computing device, from the second user, a second contribution, wherein the second contribution is based at least in part on a second round-up transaction, a second recurring transaction, or a second one-time transaction;
receiving, via the second computing device, from the second user, a second user selection of a second user investment in the entity;
purchasing, via a processor-based device, an investment in the entity using the first contribution and the second contribution;
outputting, via a display device, to the first user, a first cumulative investment metric;
outputting, via a display device, to the second user, a second cumulative investment metric; and
outputting, via a display device, to either the first or second user, one or more community investment metrics.

2. The computer-implemented method of claim 1, wherein the one or more community investment metrics comprise at least a total investment amount and/or a current social impact.

3. The computer-implemented method of claim 2, wherein the total investment amount comprises a sum of the first cumulative investment metric and the second cumulative investment metric.

4. The computer-implemented method of claim 2, wherein the current social impact comprises at least one of a number of clinical trials enabled and a total number of pathways to a cure investigated.

5. The computer-implemented method of claim 1, wherein the communication to the second user regarding the first user investment in the entity comprises providing a link to a social media platform to post information about the first user investment in the entity, an invitation to invest in the entity, and a communication sharing information about the first user investment in the entity to a group of friends or contacts.

6. The computer-implemented method of claim 1, wherein the first user and/or the second user are respectively provided a first community status and a second community status, wherein the first community status and the second community status are respectively based at least in part on the first cumulative investment amount or second cumulative investment amount.

7. The computer-implemented method of claim 1, further comprising creating a first investment community comprising at least the first user and/or the second user.

8. The computer-implemented method of claim 7, further comprising:
sending an invitation to a third user to join the first investment community.

9. The computer-implemented method of claim 8, further comprising:
creating a second investment community comprising the first user, the second user, the third user, and/or a fourth user.

10. The computer-implemented method of claim 1, wherein the first investment and second investment are provided to a for-profit organization.

11. A system for tracking community impact investments comprising:
at least one memory configured to store computer-executable instructions; and
at least one processor configured to access the at least one memory and executive the computer-executable instructions to:
receive, via a first computing device from a first user, a first contribution, wherein the first contribution is based at least in part on a first round-up transaction, a first recurring transaction, or a first one-time transaction;
receive, via the first computing device, from the first user, a first user selection of a first user investment in an entity;
provide, via the first computing device, a communication to a second user regarding the first user investment in the entity;
receive, via a second computing device from the second user, a second contribution, wherein the second contribution is based at least in part on a second round-up transaction, a second recurring transaction, or a second one-time transaction;
receive, via the second computing device, from the second user, a second user selection of a second user investment in the entity;
purchase, via a processor-based device, an investment in the entity using the first contribution and the second contribution;
output, via a display device to the first user, a first cumulative investment metric;
output, via a display device to the second user, a second cumulative investment metric; and
output, via a display device to either the first or second user, one or more community investment metrics.

12. The system of claim 11, wherein community investment metrics comprise at least a total investment amount and/or a current social impact.

13. The system of claim 11, wherein the total investment amount comprises a sum of the first cumulative investment metric and the second cumulative investment metric.

14. The system of claim 12, wherein the current social impact comprises at least one of a number of clinical trials enabled and a total number of pathways to a cure investigated.

15. The system of claim 11, wherein the communication to the second user regarding the first user investment in the entity comprises providing a link to a social media platform to post information about the first user investment in the entity, an invitation to invest in the entity, and a communication sharing information about the first user investment in the entity to a group of friends or contacts.

16. The system of claim 11, wherein the first user and/or the second user are respectively provided a first community status and a second community status, wherein the first community status and the second community status are respectively based at least in part on the first cumulative investment amount or second cumulative investment amount.

17. The system of claim 11, further comprising creating a first investment community comprising at least the first and/or second user.

18. The system of claim 17, wherein the at least one process is further configured to send an invitation, by the first and/or second user, to a third user to join the first investment community.

19. The system of claim 18, wherein the at least one process is further configured to create a second investment community comprising the first user, the second user, the third user, and/or a fourth user.

20. The system of claim 11, wherein the first investment and second investment are provided to a for-profit organization.
